(19) United States
(12) Patent Application Publication
(10) Pub. No.: US 2012/0024322 A1
(43) Pub. Date: Feb. 2, 2012

(54) SAND WAND ASSEMBLY

(76) Inventor: Randall L. Tucker, Findlay, OH (US)

(21) Appl. No.: 13/201,347

(22) PCT Filed: Feb. 12, 2010
(86) PCT No.: PCT/US2010/024071

§ 371 Date: Oct. 21, 2011

Related U.S. Application Data
(60) Provisional application No. 61/152,100, filed on Feb. 12, 2009.

(51) Int. Cl. A47L 5/14; B08B 5/04; B08B 3/02

(52) U.S. Cl. 134/10; 15/320; 134/21

(57) ABSTRACT

An apparatus and method for removing sediment from a waterway using a high pressure water spray and a suction line is disclosed. The high pressure water is directed through a pressure line. The high pressure water helps to suspend sediment that has settled in the waterway. Water and suspended sediment is then vacuumed up by the suction line and deposited outside the water for further treatment or disposal. The apparatus is designed to be hand-held by an individual situated in the waterway, such that great control over which specific locations within the waterway are being treated. An outlet from the pressure line is selectively moved between a first position to direct pressurized fluid against the waterway surface to be treated and a second position that enhances removal of the water with suspended sediment.

This application claims the priority benefit of U.S. Provisional Application Ser. No. 61/152,100, filed Feb. 12, 2009, the disclosure of which is hereby expressly incorporated herein by reference.

The present disclosure relates to particulate collection devices of the type shown and described in copending, commonly owned, related application Ser. No. 10/515,978, filed 28 Feb. 2005. More particularly, the present disclosure relates to a system and method for collecting sand, sludge and sediment from a waterway.

### BACKGROUND OF THE DISCLOSURE

It is often desirable to remove sediment and other particulate matter from a waterway such as a stream, river, channel bed, tidal pool, or estuary pool. Sediments are often soils eroded from farmland, forests, and runoff from city streets, carried by surface water, and accumulated in channel bottoms. The sediments are typically sand and silts that have been carried by the waterway or along a lake shoreline by littoral currents and deposited in the channel. A dredged material may be a clean soil or may include contaminants from a number of possible sources including runoff, sand and grit applied to roadways during the winter, sewer overflows, mining, etc.

Whatever the source, sediment removal from a channel bed is often done for a variety of reasons, including removing sediments to improve a spawning area, improving navigation by removing sand bars, removing contaminated sediment from industrial runoff in streams, and removing sediment from aqueduct and generating station intakes.

A common way to remove sediment from streams is by dredging. In conventional mechanical dredging techniques, a crane has a bucket that scoops sediment from a bottom surface of the waterway and deposits the sediment in a barge or vehicle for transport to a remote location. While effective, such dredging techniques require expensive equipment and are costly to operate. In addition, conventional “grab type” dredging techniques such as “clamshell bucket” or “drag line bucket” are designed to operate without concern for excess sediment spilling out of the buckets during operation, i.e., sediment is stirred up in the waterway and fouls downstream locations. These dredging techniques commonly produce a flume of waterborne sediments that are widely dispersed by the prevailing currents. Thus, the conventional grab type dredges are not well suited for the retrieval of contaminated marine sediments. On the other hand, hydraulic dredging produce a large volume of associated water, which is usually directed to a settling pond and returned to the waterway after the sediment has settled. When the soil contains contaminated sediments, the associated water must be treated using a remediation process before it is returned to the waterway. This requirement increases the degree of difficulty and cost of a project.

Another alternative to dredging is to use the applicant's collector assembly as shown and described in U.S. Pat. Nos. 6,042,733 and 6,346,199. One or more collectors is/are mounted in the waterway and sediment that collects in the assembly is periodically pumped on shore. This collector assembly has proven to be especially effective at removing sediment from waterways. Typically, a pump is disposed outside of the waterway and, oftentimes, associated with an ejector to provide suction to a sediment removal passage. The sediment is separated from the water by passing through a filter and clean, filtered water returned to the waterway.

These systems do not adequately address the need for a mobile or portable sediment removal, or the need to adjust the type/size of sediment removed with a portable apparatus. There is also a need to provide turbidity function that can be easily changed to a suction arrangement in order to stir up the sediment in the waterway yet remove the sediment before mixing into the remainder of the waterway.

### SUMMARY OF THE DISCLOSURE

In one aspect, the present disclosure provides an apparatus or sand wand assembly for collecting sediment from a waterway, the apparatus including a movable pressure opening that is selectively actuated between first and second operative positions. In the first position, pressurized fluid is directed out of a base of the sand wand assembly and preferably toward a bottom surface of the waterway. In the second position, the pressurized fluid is directed toward an outlet line to urge the stirred up sediment into the outlet line. The second position of the pressure opening also directs or provides water toward the suction hose to assist in priming the suction pump on startup.

A lever is selectively actuated by an associated operator to move the pressure opening between the first and second operative positions.

First and second supports extend outwardly from the base of the sand wand assembly to support the assembly on an associated bottom surface of the waterway.

The first and second supports are preferably disposed on opposite sides of the sand wand assembly.

Front and rear portions of the base of the sand wand assembly are open.

The first and second supports preferably include curvilinear regions to facilitate rocking action of the sand wand assembly on the associated bottom surface of the waterway.

The first and second supports preferably taper outwardly from a lift chamber of the sand wand assembly.

The lift chamber of the sand wand assembly preferably has a tapered conformation that increases in cross-sectional dimension as it proceeds toward the supports. The increasing area of the lift chamber reduces the suction water velocity proportionally to a ratio of the suction hose surface area divided into the lift chamber intake surface area, This provides a means to reduce the suction velocity at the intake to provide only enough velocity to remove only the fine particles of sand or silt leaving gravel and cobble in the river.

In another aspect, a method for removing sediment from a waterway includes the steps of dispensing high pressure fluid from a pressure line mounted in a hand-held housing for providing a high pressure against an associated sediment containing surface in the waterway to stir up sediment, and repositioning the pressure line to assist in directing water and sediment stirred up by the high pressure fluid into an outlet line.

The method further includes separating water from the sediment, and returning the separated water to the waterway.

One advantage of the disclosure resides in the mobility provided in removing sediment from a waterway.

Another advantage is found in the ability to easily and effectively change the position of the pressure line in the sand wand assembly.

Yet another advantage relates to the durable nature of the assembly that may be selectively varied in operation to accommodate different conditions.

Still other features and benefits of this disclosure will become apparent to those skilled in the art upon reading and understanding the following detailed description of this disclosure.

### BRIEF DESCRIPTION OF THE DRAWINGS

The present disclosure will be described in detail with several preferred embodiments and illustrated, merely by way of example and not with intent to limit the scope thereof, in the accompanying drawings.

FIG. 1 is a side view of a prior art sand wand assembly in accordance with one embodiment of the present disclosure.

FIG. 2 is a cutaway side view of the valve assembly of the sand wand in accordance with one embodiment of the present disclosure.

FIG. 3 is a plan view of the openings in one embodiment of the sand wand assembly.

FIG. 4 is a schematic diagram showing the sediment removal process in accordance with one embodiment of the present disclosure.

FIG. 5 is a schematic diagram showing the sediment removal process in accordance with a second embodiment of the present disclosure.

FIG. 6 is a schematic diagram showing the sediment removal process in accordance with a third embodiment of the present disclosure.

FIG. 7 is an elevational view, in partial cross-section of a fourth preferred embodiment in a first operative position.

FIG. 8 is an elevational view similar to FIG. 7 in a second operative position.

FIG. 9 is a side view of the right-hand side of FIG. 8.

FIG. 10 is a side view of the right-hand side of FIG. 8 after removal of the sediment.

FIGS. 11 and 12 are schematic representations of elevational and side views showing the suction or lifting region of the assembly.

FIG. 13 is a bottom view of the sand wand assembly of FIG. 10.

### DETAILED DESCRIPTION OF THE PREFERRED EMBODIMENTS

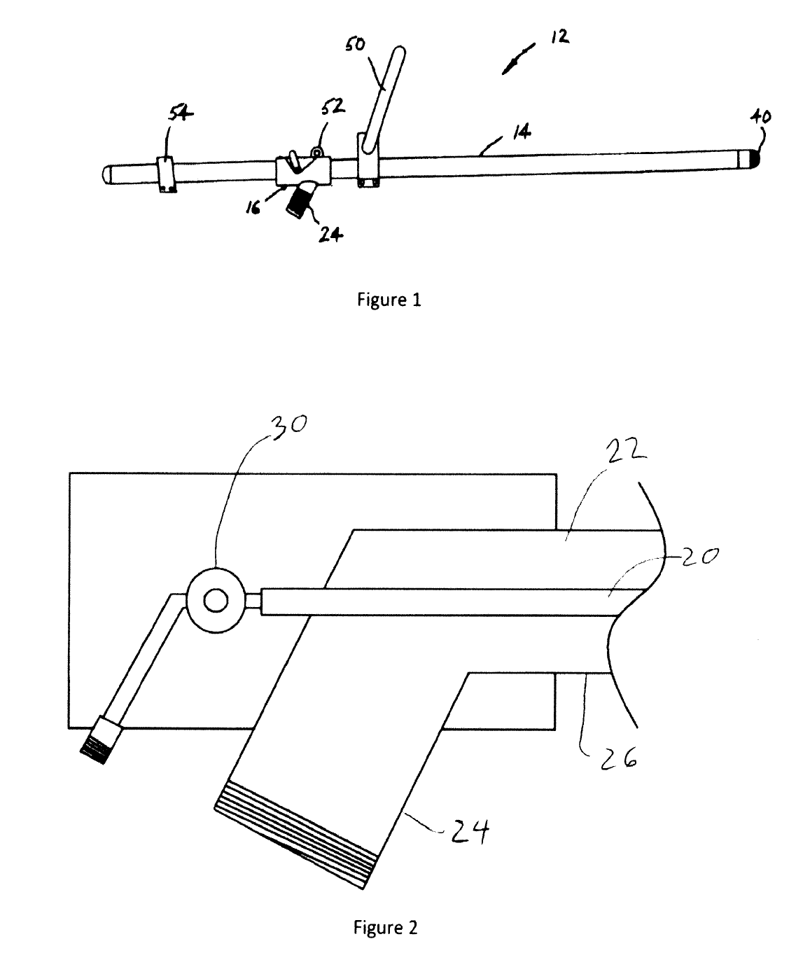

With reference to FIG. 1, a handheld sand wand assembly 12 for removing sediment and other material from a waterway is shown in accordance with one embodiment of the present disclosure. As used herein, the term “sediment” is not meant to be limiting and is intended to encompass any material that is desired to be removed from a waterway including, but not limited to, silt, sand, sewage, soil, organic and inorganic waste, runoff, etc. Similarly, a “waterway” is not intended to be limiting in any way and is meant to encompass any flowing or standing waterway such as streams, rivers, ponds, lakes, canals, estuary and tidal pools, and channels, both natural and man-made.

The sand wand assembly 12 comprises an elongated, hollow housing 14 through which water and sediment pass. More particularly, and as additionally shown in FIG. 2, the housing 14 contains a water pressure line 20 and a suction or outlet line 22. In a first embodiment, the pressure line 20 and the suction line 22 are positioned in a coaxial arrangement, with the pressure line 20 preferably nested inside the suction line 22. In this arrangement, an outer surface 24 of the suction line forms the housing, with the pressure line 20 positioned inside the suction line 22. Of course, other arrangements are contemplated by the present disclosure, such as the pressure line 20 and the suction line 22 positioned in side-by-side relation or disposed inside a separate housing. Alternatively, the coaxial relationship could be reversed. Both the suction line 22 and the pressure line 20 can be of varying sizes. Although not meant to be limiting, the suction line has an inside diameter of from about one inch to about four inches, the pressure line in turn, has an interior diameter of from about one-eighth inch to about one-half inch. As will be appreciated, the dimensions may vary to meet the particular needs for the sand wand assembly. For instance, the pressure line provides for pressurized fluid (preferably water) to pass through the sand wand assembly and exit at one thereof so that the pressurized water is directed to stir up sediment in the waterway. The suction line, on the other hand, is exposed to a vacuum force or sectional force and removes the water with stirred up (suspended) sediment from the waterway where the water with suspended sediment is treated as will be described in greater detail below.

A valve assembly 30, such as a ball valve, is provided in the assembly to control the flow of water through the pressure line 20. Preferably, the position of the valve may be varied, thereby allowing a user to make selective incremental adjustments in the amount of water flowing through the pressure line 20. Seals in the valve are preferably made from a non-corroding, chemical, oxidative and weather resistant material such as Viton, a registered trademark of E.I. DuPont de Nemours Company. Of course, alternative seal materials may be used without departing from the scope and intent of the present invention.

The pressure line 20, valve assembly 30, and suction line 22 are preferably made from a rigid, non-corroding material that is resistant to bending and fracturing and the abrasive effects of the pressurized water and water/sediment mix. For example, a preferred arrangement of the pressure line 20 and suction line 22 uses stainless steel and/or aluminum, although other materials such as rigid thermoplastic, or other non-corroding metals may be used.

As more particularly shown in FIG. 2, the valve assembly 30 is disposed in the pressure line 30 downstream of a conventional connector or fitting that sealingly connects to a high pressure source (not shown). The pressure line 20 is preferably centrally positioned in suction line 22, which also includes a conventional connector (e.g., threads, quick connect, etc.) for receiving water and sediment from line 22 and conveying the water with suspended sediment to a vacuum source such as an ejector or an inlet to a pump.

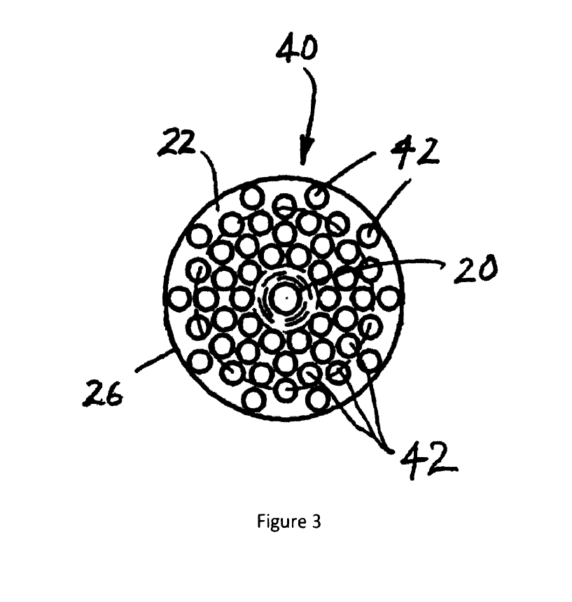

With reference to FIG. 3, an end or nose 40 is shown in accordance with one embodiment of the present invention. An end of the pressure line 20 preferably protrudes through a center of the nose 40. Disposed on the nose and generally surrounding the pressure line 20 is a plurality of suction orifices 42 through which water with sediment in suspension is removed from the waterway. Although shown as being circular in FIG. 3, the orifices 42 may adopt a wide number of shapes. The orifices 42 are preferably sized such that they will only admit sediment having a particle size that will easily pass through the suction line 22. That is, the orifices are preferably sized such that they will prevent sediment having a particulate size that is so large that the sediment is likely to become lodged in the suction line 22 from entering the tube. Thus, although not intended to be limiting, a 2-inch diameter suction line 22 would typically have a nose with an orifice diameter size of from about 0.2 to about 0.6 inches. It has been determined, however, that in many instances the multiple orifice arrangement of FIG. 3 is not desirable, so that one skilled in the art will recognize that still other conformations of the intake end of the suction line such as described below could be used without departing from the scope and intent of the present disclosure.

In operation, the sand wand assembly 12 is preferably hand held by an individual operator. An optional handle 50 assists the operator in holding the apparatus and a shoulder strap (not shown) may be attached to the apparatus. A counterweight 54 may be located on the housing 4 and positioned at various points along its length to effectively balance the sand wand assembly 12 in the operator's hands. Since the sand wand assembly 2 is hand operated, it finds particular usefulness in the remediation of shallow streams and rivers in which the operator may stand in the water bed with his or her head above water and the nose cone 40 of the suction line 22 directed under the water. The apparatus can be used in deeper applications, however, if the operator is equipped with an underwater breathing apparatus, such as a scuba. In addition, by being hand operated, the sand wand assembly 12 allows unprecedented control over which specific locations within a waterway area to be treated.

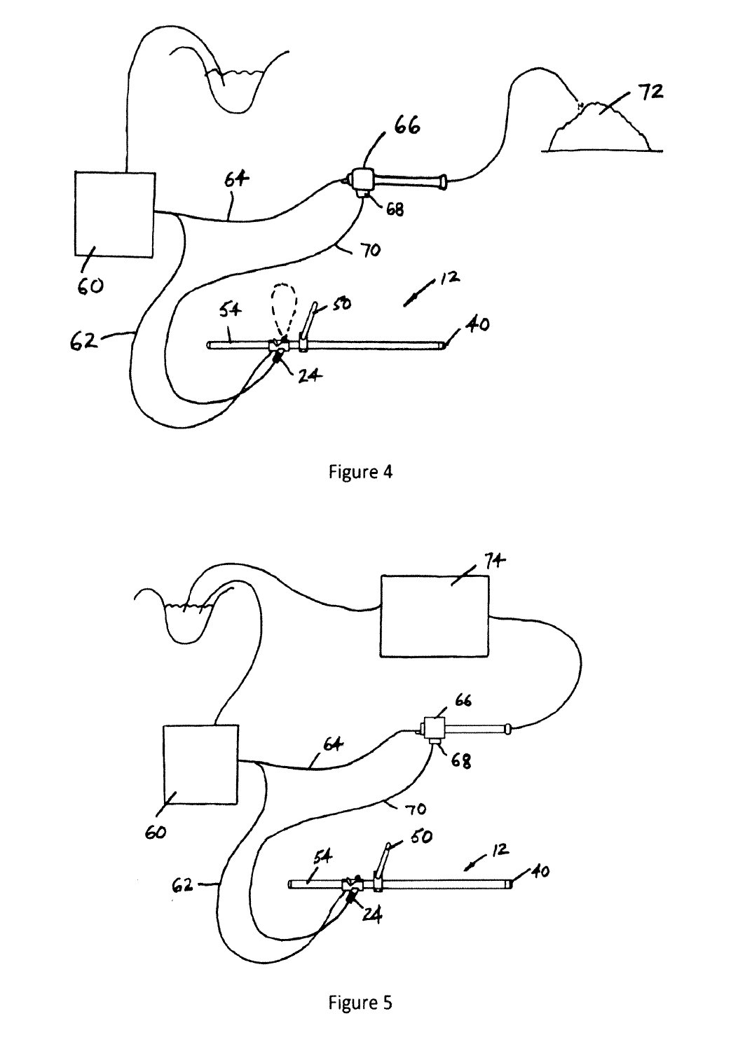

With reference to FIG. 4, a single speed or variable speed pump 60 pumps water through a first supply hose or tube 62 to the inlet valve stem on the valve assembly and through a second supply hose 64 or tube to an ejector 66 or pump. The water may come from a downstream area of the waterway that is to be cleaned or from an already filtered waterway. The water to the pump 60 is preferably drawn from a clean waterway without a large sediment content. This will ensure that the pump 60 operates smoothly and that the pump life is not unnaturally shortened due to large amounts of sediments contaminating the interior components of the pump 60. Any pressure-generating pump with sufficient gallon per minute (gpm) flow can be used. Thus, the pump 60 can be gasoline, diesel, solar or electric powered.

The water supplied to the inlet valve stem is sent through the pressure line 20 and is ejected as a high-pressure jet of water at the line's tip at the center of the nose cone 40. This high-pressure jet of water can be directed at the floor or other surface of the water bed that contains settled sediment, effectively stirring up settled sediment and suspending it temporarily in the waterway. The sediment and water suspension may then be collected.

The stirred-up sediment is suctioned through the orifices 42 and into the suction line 22 along with water. The suctioning force is provided by the ejector 66. The ejector is a device that is capable of generating a reduced pressure in the suction line, thus allowing water and sediment to be vacuumed up through the suction line 22 and deposited for treatment or disposal. In one embodiment, illustrated in the accompanying Figures, the ejector 66 is a housed venturi jet with pressurized water supplied by the pump through the second supply hose 64.

In this embodiment, the passing of this pressurized water through the venturi creates a vacuum, which generates a suction on an input nozzle 68 of the ejector. This input nozzle 68 is connected to the outlet connector on the valve assembly of the sand wand assembly 12 by a connection hose 70. This creates a suctioning effect, which draws sediment from the waterway, through the nose cone 40 into the suction line 22, from the suction line 22 through the connection hose 70, and into the ejector 66. In the ejector 66, the sediment is mixed with the high pressure water from the second supply hose 64 and the resulting effluent is carried to a pile or hopper 72 to be disposed of or separated. Alternately, as shown in FIG. 5, the effluent may be directed to a filter 74, which separates the water from the sediment and returns clean water to the waterway.

All parts of the above-described system must be matched to provide optimum results. Pump 60 and ejector 66 size are important considerations. Thus, in a preferred embodiment, a typical pump 60 will preferably produce at least one hundred psi water pressure at the ejector 66 to generate sufficient suction for the sand wand assembly 12. Therefore, a pump 60 that can produce at least this pressure, taking into consideration all factors such as ejector 66 size, suction line 22 diameter and elevation to which the water is to be pumped, is needed. For example, in a typical installation with the ejector 66 sitting ten feet above the waterway and pumping the effluent fifty feet on the level, a 2-inch ejector 66 would generate a suction of about thirty to about forty gpm through the suction line 22 with a pump 60 supplying water to the ejector at one hundred psi.

The pressure of the water exiting the pressure line 20 can be regulated using the valve 30. Thus, the water pressure directed through the sand wand assembly 12 may be manually controlled in response to the operator's wishes and the conditions of the waterway. For example, in especially turbid water, the use of a water jet may be unnecessary to suspend sediment and the valve 30 can be turned off. Likewise, suction can be controlled by regulating the pump speed in a variable speed pump 60 in response to operator's desires or varying water conditions.

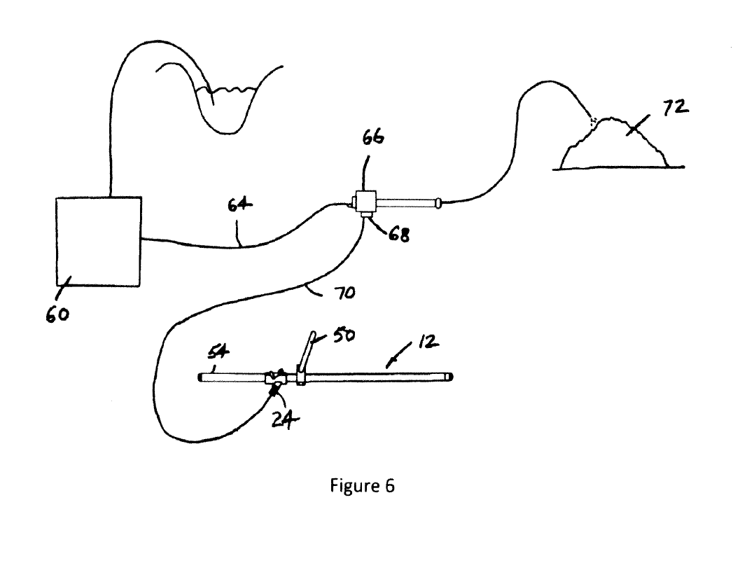

In another embodiment of the invention, shown in FIG. 6, the pressure line 20 is eliminated from the sand wand assembly 12. In this embodiment, the sand wand assembly 12 merely acts as a suctioning device, without the use of a high-pressure water jet to stir up sediment in the waterway. In this embodiment, of course, the inlet valve, pressure line and first supply hose described in the previous embodiments are not present or not used. Other aspects of the process remain the same however, with the ejector 66 creating a vacuum, which suctions sediment from the water, passes it through the suction line 22, connector hose 70 and ejector 66 and deposits it in a hopper or filter for collection or treatment.

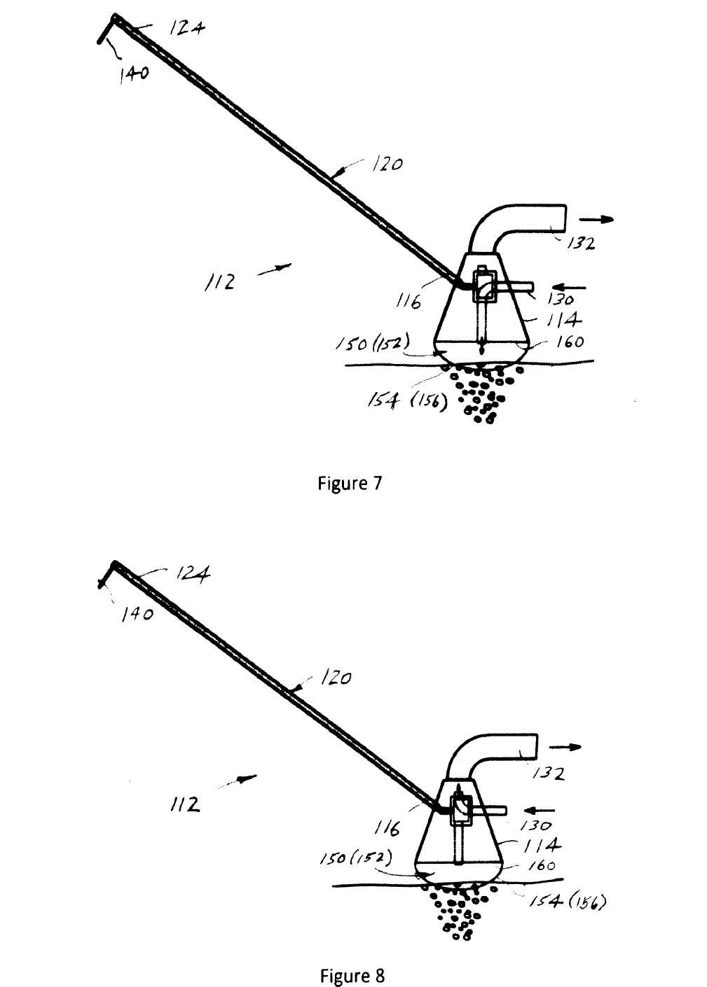

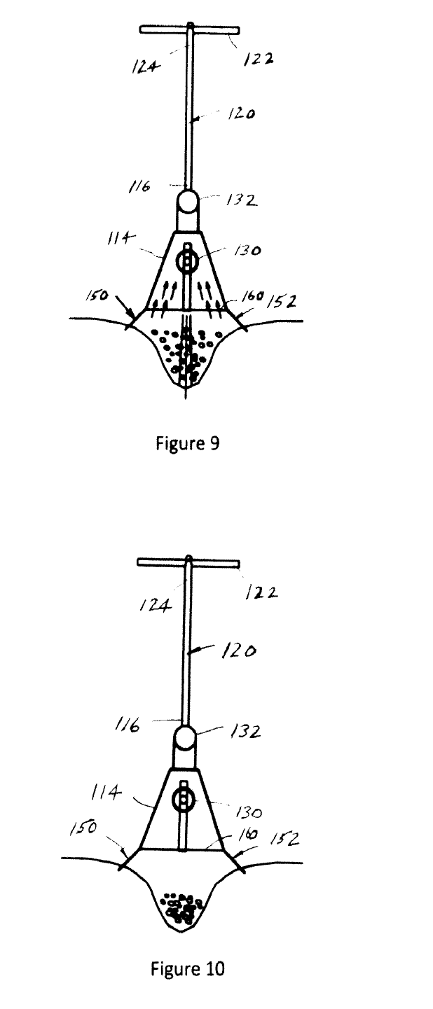

Turning to FIGS. 7-13, yet another embodiment of the disclosure will be described in greater detail. Particularly, sand wand assembly 112 includes a housing 114 at one end 116 of an elongated shaft 120. A handle or cross bar 122 is provided at a second end 124 of the shaft, for example a t-bar, so that an operator can move the sand wand assembly into a desired position or location in the waterway. In addition, a pressure line 130 terminates within the housing and the suction or outlet line 132 also communicates with the interior of the housing. The housing forms a lift chamber intake that is open at a first or lower end to receive the sand/silt/water slurry and the slurry communicates with the outlet line shown here as being disposed at a second or upper end of the housing or lift chamber. The orientation of the terminal end of the pressure line 130 may be selectively changed by the sand wand assembly operator so that in a first position the pressurized fluid is directed outwardly from the terminal end toward the surface of the waterway requiring treatment. Thus, as illustrated in FIG. 7, the terminal end of the pressure line is directed outwardly through the open bottom of the housing and toward the bottom surface of the waterway. The sediment that is located in the waterway surface is contacted by the pressurized fluid which causes the sand, cobble, and gravel to tumble thus polishing the gravel with sand slurry and at the same time sand and silt to be extracted through the outlet line. This process will remove all the sand and silt from the desired area leaving gravel, cobble, and larger substrate material behind (FIGS. 9 and 10).

The orientation of the pressure line end is selectively altered by the operator. Particularly, a lever 140 is provided at the second end 124 of the shaft. By moving the lever, the operator can actuate the pressure line end toward the suction line. This second position supplies a water pressure jet into the suction line of the housing. The design of the housing and the assistance provided by the water pressure jet in this second position provides a venturi action that assists in directing the water with suspended sand and slurry into the outlet line. Further, the second position of the pressure line end is useful in priming the outlet line.

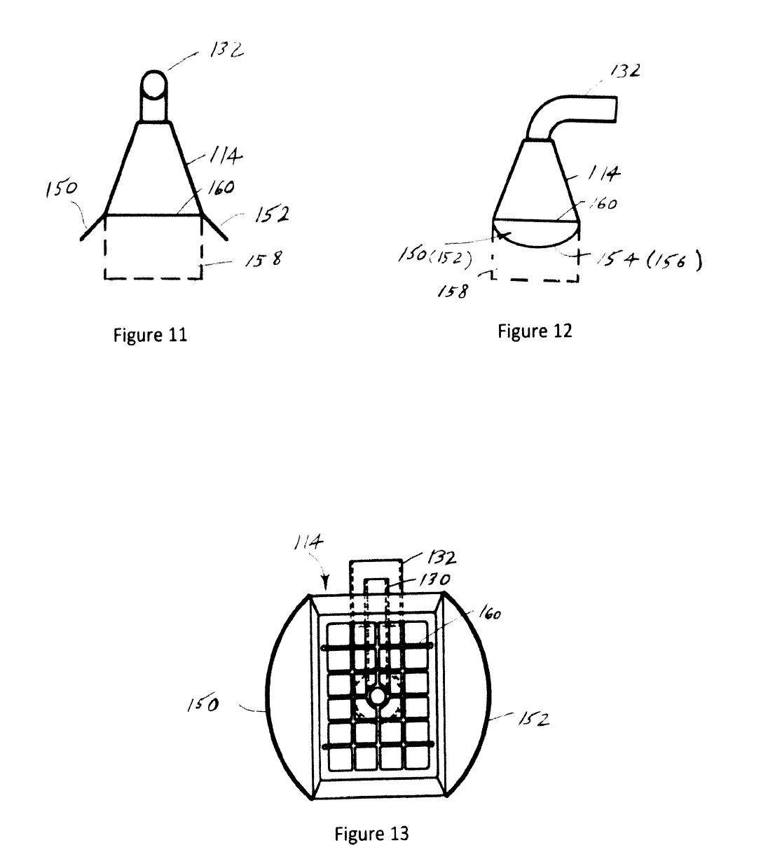

First and second supports 150, 152 extend outwardly from the housing 114 to support the housing on an associated bottom surface of the waterway. The first and second supports are preferably disposed on opposite sides of the sand wand assembly, and preferably have curvilinear or arcuate regions 154, 156 along a portion thereof to allow the housing to rock on the bottom surface of the waterway and help direct the pressurized fluid against the bottom surface of the waterway. In this manner, a lifting area 158 beneath the housing is effectively scoured by the pressurized fluid, and the silt and sand are effectively removed. The supports 150, 152 also preferably taper outwardly from the base of the housing (FIGS. 9-10), although the area from which sand and silt is lifted is more directly located beneath the perimeter of housing (FIGS. 11-12). The supports hold the sand wand assembly above the waterway surface to eliminate the lifting area from locking down on the waterway surface which could otherwise cause the water to be extracted from the sand and lock the housing to the sandy bottom with the suction or vacuum of the outlet line.

FIG. 13 shows an optional open mesh screen 160 that overlies the outlet line, i.e., is disposed between the intake end of the lift chamber and the entrance to the outlet line. The openings, the distance of the housing above the bottom surface of the waterway, and the suction force applied at the outlet line all serve to provide control over the size of the material that is removed from the waterway.

Although the hand-held sand wand assembly described in the previous embodiments finds particular application in shallow waterways or in regions where it is difficult to bring in larger equipment, some of these features of the housing are fully applicable to a scaled up version. For example, the housing can be enlarged and mounted on the end of a backhoe or crane in order to advantageously use many of the features of the present disclosure in regions of a waterway where heavy equipment can be positioned in place. In other instances, the screen can be removed from the housing. The lifting velocity created by the suction from the outlet line determines the size of the material removed since it will be understood that higher velocities are required to lift larger sized particles into the lift chamber of the housing.

The invention has been described with reference to illustrated embodiments. Obviously, modifications and alterations will occur to others upon a reading and understanding of the preceding detailed description. It is intended that the invention be construed as including all such alterations and modifications insofar as they come within the scope of the above description.

What is claimed is:

1. An apparatus for collecting sediment from a waterway, said apparatus comprising:
a pressure line having an opening for providing pressurized fluid;
an outlet line for receiving sediment and water from the waterway; and
a movable pressure opening that is selectively actuated between first and second different operative positions, such that in the first position, pressurized fluid is directed out of the pressure line opening toward a bottom surface of the waterway and in the second position, the pressurized fluid is directed toward the outlet line to urge stirred up sediment into the outlet line.

2. An apparatus according to claim 1 further comprising a lever selectively actuated by an associated operator to move the pressure opening between the first and second operative positions.

3. An apparatus according to claim 1 further comprising first and second supports extend outwardly from the housing to support the housing on an associated bottom surface of the waterway.

4. An apparatus according to claim 3 wherein the first and second supports are preferably disposed on opposite sides of the sand wand assembly.

5. The apparatus according to claim 4 wherein front and rear portions of the housing are open.

6. The apparatus according to claim 3 wherein the first and second supports preferably include curvilinear regions to facilitate rocking action of the housing on the associated bottom surface of the waterway.

7. The apparatus according to claim 3 wherein the first and second supports preferably taper outwardly from the housing.

8. The apparatus according to claim 3 wherein the housing has a tapered conformation that increases in cross-sectional dimension as it proceeds toward the supports.

9. An apparatus according to claim 1 further comprising a valve for controlling the rate at which fluid passes through said pressure line.

10. An apparatus according to claim 9 wherein said valve is a variable flow valve allowing selective variable regulation of the vacuum force in the suction line.

11. An apparatus according to claim 1 further comprising a handle extending from said suction line for manipulating the apparatus.

12. An apparatus for collecting sediment from a waterway, said apparatus comprising:
a pressure line;
a suction line;
a housing encompassing terminal ends of the pressure and suction lines and having an open base;
a movable pressure opening that is selectively actuated between first and second different operative positions, such that in the first position, pressurized fluid is directed out of the pressure line opening from the open base and toward an associated bottom surface of the waterway and in the second position, the pressurized fluid is directed toward the suction line to urge stirred up sediment into the suction line.

13. An apparatus according to claim 12 further comprising a lever selectively actuated by an associated operator to move the pressure opening between the first and second operative positions.

14. An apparatus according to claim 12 further comprising first and second supports extend outwardly from the housing to support the housing on an associated bottom surface of the waterway.

15. An apparatus according to claim 12 wherein the housing and suction line are configured to preselect the size of particles removed from the associated waterway.

16. A method for removing sediment from an associated waterway, the method including the steps of:
dispensing high pressure fluid from a pressure line mounted in a housing for providing a high pressure fluid flow toward an associated sediment containing surface in an associated waterway to stir up sediment; and
directing the high pressure fluid toward an outlet line operatively associated with the housing to vacuum water and sediment stirred up by the high pressure water.

17. A method according to claim 16, further comprising separating said water from said sediment.

18. A method according to claim 17, returning said separated water to said waterway.

19. A method according to claim 16, further comprising the step of manually controlling the amount of high pressure water dispensed through said pressure line by use of a valve.

20. A method according to claim 16, further comprising the step of adjusting the rate at which water and sediment is vacuumed through said suction line by adjusting the pump speed.

21. A method according to claim 16, wherein the position of the high pressure fluid from the pressure line at a first end of a handle is selectively operated by a lever at a second end of the handle.

22. A method according to claim 16, further comprising applying a vacuum to the housing to remove fluid and suspended sediment therefrom.

23. A method according to claim 16, further comprising configuring the housing and vacuum to preselect the size of the particles removed from the waterway.
